(19) United States
(12) Patent Application Publication
(10) Pub. No.: US 2023/0071923 A1
(43) Pub. Date: Mar. 9, 2023

(54) TASK ASSIGNMENT ARTIFICIAL INTELLIGENCE

(71) Applicant: Citrix Systems, Inc., Ft. Lauderdale, FL (US)

(72) Inventors: Ze Chen, Nanjing (CN); Kun Li, Nanjing (CN)

(73) Assignee: Citrix Systems, Inc., Ft. Lauderdale, FL (US)

(21) Appl. No.: 17/452,461

(22) Filed: Oct. 27, 2021

Related U.S. Application Data
(63) Continuation of application No. PCT/CN2021/116569, filed on Sep. 4, 2021.

(51) Int. Cl. G06Q 10/06; G06F 3/0482

(52) U.S. Cl. CPC G06Q 10/063112; G06Q 10/06312; G06F 3/0482

(57) ABSTRACT

A computing device configured to provide recommended candidates for completion of an assigned task to a user assigning the task is provided. The computing device includes a memory, a user interface, and at least one processor coupled to the memory and the user interface. The at least one processor is configured to receive input specifying information regarding the task, determine one or more task specifics associated with the task from the task information, identify candidate value information regarding one or more candidates to complete the task, compare the one or more task specifics to the candidate value information regarding the one or more candidates to determine one or more match scores of the one or more candidates, organize a list of recommended candidates based upon the one or more match scores, and display, on the user interface, at least a portion of the list of recommended candidates.

### CROSS-REFERENCE TO RELATED APPLICATION

This application claims priority under 35 U.S.C. § 120 as a continuation of PCT Application No. PCT/CN2021/116569, entitled “TASK ASSIGNMENT ARTIFICIAL INTELLIGENCE” and filed Sep. 4, 2021. PCT Application No. PCT/CN2021/116569 is hereby incorporated herein by reference in its entirety.

### BACKGROUND

In modern distributed work environments, task assignment can be implemented as an automated process. A manager or other similar person assigning a task can access a task assignment or resource management application such as the Jira management tracking software developed by Atlassian of Sydney, Australia. When assigning a task, the assignor can generally select from a list of potential assignees. However, this list of potential assignees is static and limited in scope. For example, the list of potential assignees can be limited to people the assignor has previously selected for a task or all employees within a group or organization.

### SUMMARY

In at least one example, a computing device configured to provide recommended candidates for completion of an assigned task to a user assigning the task is provided. The computing device includes a memory, a user interface, and at least one processor coupled to the memory and the user interface. The at least one processor is configured to receive input specifying information regarding the task, determine one or more task specifics associated with the task from the task information, identify candidate value information regarding one or more candidates to complete the task, compare the one or more task specifics to the candidate value information regarding the one or more candidates to determine one or more match scores of the one or more candidates, organize a list of recommended candidates based upon the one or more match scores, and display, on the user interface, at least a portion of the list of recommended candidates.

Implementations of the computing device configured to provide recommended candidates for completion of an assigned task to a user assigning the task can include one or more of the following features.

In examples of the computing device, the one or more task specifics can include data specifying one or more of area of expertise, a priority level, or an expected completion date, and the at least one processor can be further configured to determine the one or more match scores of the one or more candidates based upon at least one of the area of expertise associated with the task, the priority level associated with the task, and the expected completion date associated with the task.

In examples of the computing device, the at least one processor being configured to determine one or more task specifics associated with the task from the task information can include the at least one processor being further configured to parse a text string contained within the task information to determine one or more keywords and identify one or more of an area of expertise, a priority level, or an expected completion date based upon the one or more keywords. In some examples, the processor being configured to identify candidate value information regarding one or more candidates to complete the task can include the at least one processor being further configured to determine historic information for each of the one or more candidates and determine current availability information for each of the one or more candidates.

In some examples, the at least one processor being configured to compare the one or more task specifics to the candidate value information regarding the one or more candidates to determine the one or more match scores of the one or more candidates can include the at least one processor being configured to compare the one or more keywords against the historic information to generate a historical working score for each of the one or more candidates, compare the one or more keywords against the current availability information to generate a current working score for each of the one or more candidates, and combine at least a portion of the historical working score and the current working score for each of the one or more candidates to determine the one or more match scores. In some examples, the at least one processor can be further configured to weight an impact of each of the historical working score and the current working score on the one or more match scores based upon at least one of the area of expertise associated, the priority level, and the expected completion date.

In examples of the computing device, the at least one processor can be further configured to receive user-inputted task information during generation of a new task assignment ticket within a task assignment application and display, on the user interface, the at least a portion of the list of recommended candidates within the task assignment application during creation of the new task assignment ticket.

In another example, a method for providing recommended candidates for completion of an assigned task to a user assigning the task is provided. The method includes receiving, by at least one processor, input specifying information regarding the task; determining, by the at least one processor, one or more task specifics associated with the task from the task information; identifying, by the at least one processor, candidate value information regarding one or more candidates to complete the task; comparing, by the at least one processor, the one or more task specifics to the candidate value information regarding the one or more candidates to determine one or more match scores of the one or more candidates; organizing, by the at least one processor, a list of recommended candidates based upon the one or more match scores; and displaying, by the at least one processor on a user interface operably coupled to the at least one processor, at least a portion of the list of recommended candidates.

Implementations of the method for providing recommended candidates for completion of an assigned task to a user assigning the task can include one or more of the following features.

In examples of the method, the one or more task specifics can include data specifying one or more of area of expertise, a priority level, and an expected completion date, and the method can further include determining, by the at least one processor, the one or more match scores of the one or more candidates based upon at least one of the area of expertise associated with the task, the priority level associated with the task, and the expected completion date associated with the task.

In examples of the method, determining one or more task specifics associated with the task from the task information can include parsing, by the at least one processor, a text string contained within the task information to determine one or more keywords and identifying, by the at least one processor, one or more of an area of expertise, a priority level, or an expected completion date based upon the one or more keywords. In some examples, identifying candidate value information regarding one or more candidates to complete the task can include determining, by the at least one processor, historic information for each of the one or more candidates and determining, by the at least one processor, current availability information for each of the one or more candidates. In some examples, comparing the one or more task specifics to the candidate value information regarding the one or more candidates to determine the one or more match scores of the one or more candidates can include comparing, by the at least one processor, the one or more keywords against the historic information to generate a historical working score for each of the one or more candidates; comparing, by the at least one processor, the one or more keywords against the current availability information to generate a current working score for each of the one or more candidates; and combining, by the at least one processor, at least a portion of the historical working score and the current working score for each of the one or more candidates to determine the one or more match scores. In some examples, the method can further include, weighting, by the at least one processor, an impact of each of the historical working score and the current working score on the one or more match scores based upon at least one of the area of expertise associated, the priority level, and the expected completion date.

In examples of the method, the method can further include 8, further include receiving, by the at least one processor, user-inputted task information during generation of a new task assignment ticket within a task assignment application and displaying, by the at least one processor on the user interface, the at least a portion of the list of recommended candidates within the task assignment application during creation of the new task assignment ticket.

In another example, a non-transitory computer-readable medium storing computer-executable instructions to provide recommended candidates for completion of an assigned task to a user assigning the task is provided. The instructions include instructions to receive input specifying information regarding the task, determine one or more task specifics associated with the task from the task information, identify candidate value information regarding one or more candidates to complete the task, compare the one or more task specifics to the candidate value information regarding the one or more candidates to determine one or more match scores of the one or more candidates, organize a list of recommended candidates based upon the one or more match scores, and display, on a user interface operably coupled to the non-transitory computer readable medium, at least a portion of the list of recommended candidates.

Implementations of the non-transitory computer-readable medium storing computer-executable instructions to provide recommended candidates for completion of an assigned task to a user assigning the task can include one or more of the following features.

In examples of the non-transitory computer-readable medium, the one or more task specifics can include data specifying one or more of area of expertise, a priority level, or an expected completion date, and the instruction can further include instructions to determine the one or more match scores of the one or more candidates based upon at least one of the area of expertise associated with the task, the priority level associated with the task, and the expected completion date associated with the task.

In examples of the non-transitory computer-readable medium, the instructions to determine one or more task specifics associated with the task from the task information can include instructions to parse a text string contained within the task information to determine one or more keywords and identify one or more of an area of expertise, a priority level, or an expected completion date based upon the one or more keywords. In some examples, the instructions to identify candidate value information regarding one or more candidates to complete the task can include instructions to determine historic information for each of the one or more candidates and determine current availability information for each of the one or more candidates. In some examples, the instructions to compare the one or more task specifics to the candidate value information regarding the one or more candidates to determine the one or more match scores of the one or more candidates can include instructions to compare the one or more keywords against the historic information to generate a historical working score for each of the one or more candidates, compare the one or more keywords against the current availability information to generate a current working score for each of the one or more candidates, and combine at least a portion of the historical working score and the current working score for each of the one or more candidates to determine the one or more match scores.

In some examples, the instructions can further include instructions to weight an impact of each of the historical working score and the current working score on the one or more match scores based upon at least one of the area of expertise associated, the priority level, and the expected completion date.

In examples of the non-transitory computer-readable medium, the instructions can further include instructions to receive user-inputted task information during generation of a new task assignment ticket within a task assignment application and display, on the user interface, the at least a portion of the list of recommended candidates within the task assignment application during creation of the new task assignment ticket.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a system architecture for accessing a distributed workspace by multiple client devices.

FIG. 2 is a block diagram of a system architecture for artificially intelligent task assignment, in accordance with an example of the present disclosure.

FIG. 3 is a block diagram of a sample network environment of computing devices in which various aspects of the present disclosure can be implemented.

FIG. 4 is a block diagram of a cloud computing environment in which various aspects of the present disclosure can be implemented.

FIG. 5 is a screenshot of a task assignment application, in accordance with an example of the present disclosure.

FIG. 6 is a flow diagram for generating artificially intelligent task assignment recommendations, in accordance with an example of the present disclosure.

FIG. 7 is a flow diagram for aggregating and organizing employee data, in accordance with an example of the present disclosure.

FIG. 8 is a flow diagram for scoring individual candidates to perform a task, in accordance with an example of the present disclosure.

FIG. 9 is a sequence diagram for generating artificially intelligent task assignment recommendations, in accordance with an example of the present disclosure.

FIG. 10 is a screenshot of an artificially intelligent task assignment application, in accordance with an example of the present disclosure.

FIG. 11 is a screenshot of a messaging application showing artificially intelligent task recommendation information, in accordance with an example of the present disclosure.

FIG. 12 is a block diagram of one or more of the computing devices as described herein, in accordance with at least one example of the present disclosure.

### DETAILED DESCRIPTION

As summarized above, various examples described herein are directed to systems and methods for recommending candidates to a user of a task assignment application. For example, the systems and methods as described herein provide for monitoring and processing of information regarding a new task assignment and providing a list of one or more candidates to complete the new task assignment, the list organized based upon a matching score for each of the one or more candidates.

Some task assignment applications include an automated process for generating a new task assignment ticket. In some examples, the automated process includes the option for the creator of the new task assignment ticket to assign one or more employees to complete the task. Generally, this option includes a listing of employees from which the creator of the new task assignment ticket can select. However, this listing of employees is generally limited in scope and the information contained therein. For example, the listing of employees may be limited to employees that the creator of the new task assignment ticket has previously interacted with, members of a team that the creator of the new task assignment ticket is also a member of or otherwise associated with, or, in some examples, the listing of employees can merely be an alphabetical or otherwise organized listing of all employees within an organization. The assignor generally has no knowledge of who is the best candidate for a task beyond their personal knowledge of the candidates. The assignor can ask around to other coworkers or use additional tools to gather information about the best candidate. However, the assignor may still require additional information such as candidate availability (e.g., are they already assigned another task or are they scheduled for time off) and, as such, selecting the most appropriate candidate to assign a task to can be a complicated and time-consuming process Without additional knowledge of the candidates contained within the list, the creator of the new task assignment ticket is limited to their own personal knowledge and experience with the candidates to select the most appropriate candidate for the new task assignment.

The systems and methods as described herein overcome the disadvantages and limitations of traditional task assignment applications by analyzing information contained within the new task assignment ticket as well as historic and current employee information to generate a listing of recommended candidates for a new task assignment. For example, information related to employees within an organization is monitored and associating scoring values are generated and assigned to each employee. When a new task assignment ticket is created, information related to the new task assignment can be analyzed and compared to the associated scoring values for each employee. Based upon this comparison, and matching score for each employee can be created, the matching score indicating how likely the employee is to be a good candidate for completing the task. An organized list of recommended candidates to complete the task can be generated to present to the creator of the new task assignment ticket for consideration when selecting an employee to assign to the task. Thus, and in accordance with at least some examples as disclosed herein, systems and methods for determining candidate recommendations for a new task assignment are provided. These systems and methods enhance the overall benefit of a task assignment application to a user, as well as the user's overall experience with a task assignment application, by providing personalized and historically analyzed candidate recommendations based upon information contained within the new task assignment ticket. Thus, a person assigning a task with limited knowledge of one or more employees experiences and current availability can quickly and efficiently select the most appropriate candidate to assign a new task for completion.

In some examples, a computing device for providing recommended candidates for a new task assignment is provided. The computing device includes a memory and at least one processor operably coupled to the memory. The processor can be configured to receive task information from a user assigning a task. For example, the user can be using a task assignment application to create a new task assignment ticket. As the user enters information into the task assignment application, the processor can receive the information from the application. The processor can be further configured to process the task information to determine one or more task specifics associated with the task and identify a group of candidates to complete the task. For each person within the group of candidates, the processor can compare the one or more task specifics to determine a candidate match score. Based upon the match scores, the processor can organize a list of recommended candidates and output at least a portion of the list of recommended candidates to the user via, for example, the task assignment application.

Examples of the methods, systems, and processes discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Sample Computing Systems

In some examples, a distributed system is configured to implement workspace and system access to remote users, thereby providing a central repository of applications, files, and other similar resources to a group of trusted users accessible via, for example, an enterprise service. A distributed workspace can be implemented as a software framework designed to deliver and manage a user's applications, data, and desktops in a consistent and secure manner, regardless of the user's device or location. Distributed workspaces enhance the user experience by streamlining and automating those tasks that a user performs frequently, such as approving expense reports, assigning projects, project management, confirming calendar appointments, submitting helpdesk tickets, and reviewing vacation requests. A distributed workspace allows users to access functionality provided by multiple enterprise applications—including software as a system (SaaS) applications, web applications, desktop applications, and proprietary applications—through a single interface.

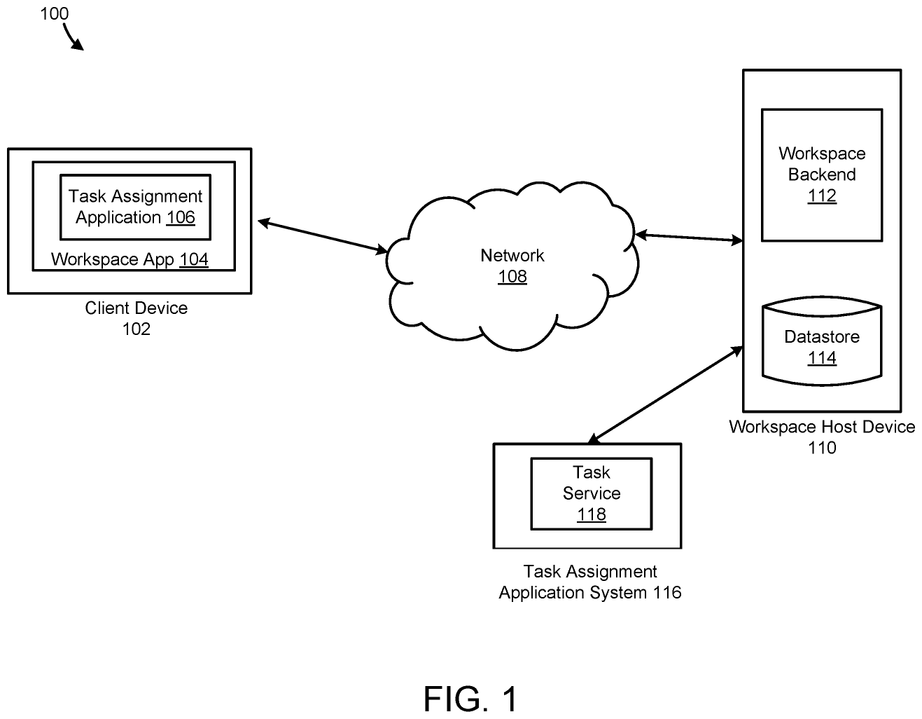

FIG. 1 illustrates a logical architecture of one implementation of a distributed workspace system 100 that is configured to connect one or more client computing devices with one or more remote computing devices configured to host shared resources such as applications accessible via the distributed workspace. As shown in FIG. 1, the system 100 can include a client device 102. As further shown in FIG. 1, client devices 102 can include a workspace application 104. The workspace application 104 can be configured to provide an interface to facilitate remote access to one or more resources hosted at or by, for example, a remote computing device such as workspace host device 110. In certain implementations, the client device 102 can be operably connected to the remote computing device via one or more networks 108. In some examples, the network 108 can be a wired network, a wireless network, or a combination of both wired and wireless networks.

In some examples, the workspace host device 110 can execute, operate, or otherwise provide an application that can be any one of the following: software; a program; executable instructions; a virtual machine; a hypervisor; a web browser; a web-based host application; a client-server application; a thin-client computing host application; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol (HTTP) client; a File Transfer Protocol (FTP) client; an Oscar client; a Telnet client; or any other set of executable instructions.

In some examples, the workspace host device 110 can execute a remote presentation services program or other program that uses a thin client or a remote-display protocol to capture display output generated by an application executing on the remote computing device. The remote computing device 110 can further transmit the application display output to the client device 102 for presentation to one or more device users.

In some examples, the workspace host device 110 can include a server agent that is configured to communicate with the workspace application 104. The server agent can be configured to, for example, authenticate a client device and provide secure access to one or more remote and/or shared resources. The server agent can further monitor user interactions with the resources, update user access based upon changes to user permission levels for a client device, distribute or properly direct requests to available resources, and perform other similar distributed workspace functions.

In yet other examples, the workspace host device 110 can be configured to execute a virtual machine providing access to a computing environment to a user of client device 102. The virtual machine can be managed by, for example, a hypervisor, a virtual machine manager (VMM), or any other hardware virtualization technique within the workspace host device 110.

In some examples, the network 108 can be: a local area network (LAN); a metropolitan area network (MAN); a wide area network (WAN); a primary public network; and a primary private network. Additional examples can include a network 108 of mobile telephone networks that use various protocols to communicate among mobile devices. For short range communications within a wireless local-area network (WLAN), the protocols can include 802.11, Bluetooth, and Near Field Communication (NFC).

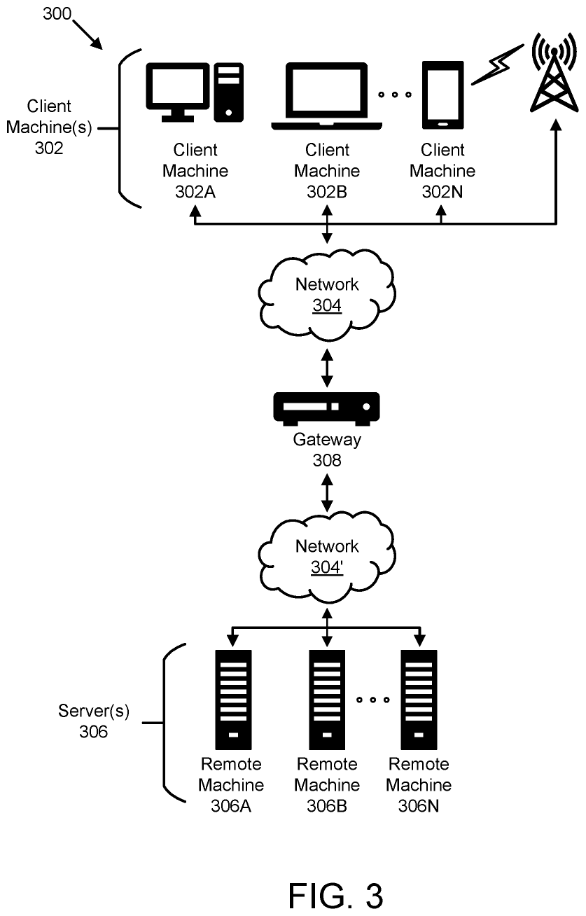

It should be noted that the specific device architecture as shown in FIG. 1 is provided by way of example only. For instance, in certain implementations, multiple remote computing devices can be operably connected to the client devices via, for example, one or more network appliances configured to perform, for example, access control and load balancing. Additional network examples and associated devices are described below in the discussion of FIG. 3.

In a typical distributed workspace, a user of the client device 102 can access a task assignment application interface 106 through, for example, the workspace application 104. For example, the user can assign one or more tasks or projects to be completed to other users of the distributed workspace system 100 using the task assignment application interface 106. Task assignment information and/or data can be processed by the workspace application 104 and transmitted to a workspace backend 112 on the workspace host device 110.

As noted above, to further process task assignment application information, the distributed workspace system 100 can include a task assignment application system 116. As further shown in FIG. 1, the task assignment application system 116 (e.g., Jira or another similar task assignment application) can include task service 118. The task service 118 can be configured to collect employee information in order to generate one or more candidate recommendations for task to be completed. It should be noted that the task assignment application system 116, and the associated task service 118, are shown as operably coupled to the workspace host device in FIG. 1 by way of example only. In certain implementations, the task assignment application system can be directly integrated into, for example, the workspace backend 112 or another component or system of the workspace host device 110. In another example, the task assignment application system 116 can be coupled to the workspace host device via network 108.

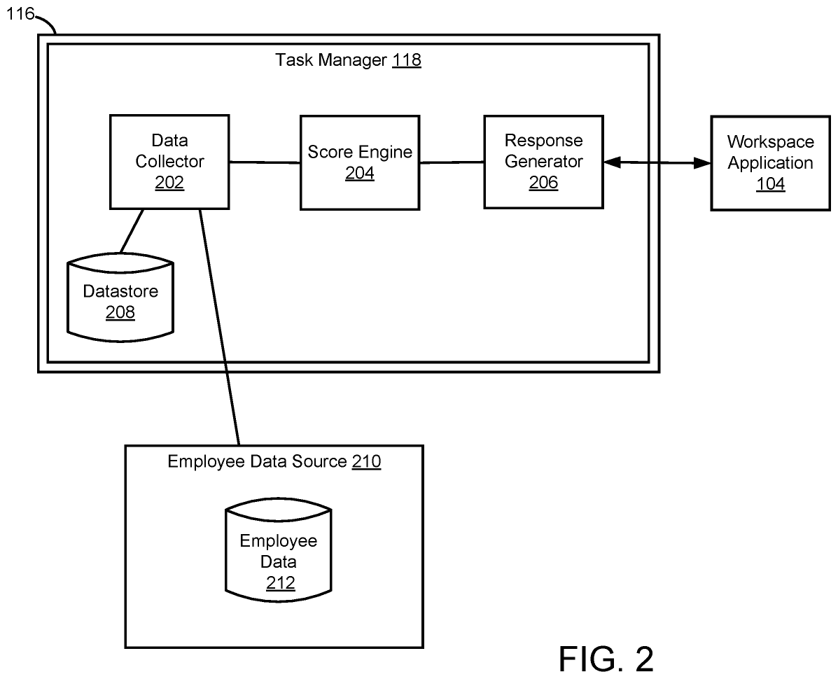

FIG. 2 illustrates a detailed view of the task assignment application system 116 and the task service 118. For example, the task assignment application system 116 can be configured to receive information related to a task to be assigned to one or more candidates, process the one or more tasks to be assigned to determine the most appropriate candidates for a particular task, and return a set of one or more recommended candidates.

As further shown in FIG. 2, the task assignment application system 116 can include a data collector 202, a score engine 204, a response generator 206, and a datastore 208. In certain implementations, the task assignment application system can be operably connected to or otherwise in communication with an employee data source 210. In some examples, the employee data source 210 can include a set of employee data 212 stored, for example, as a data structure such as an indexed and searchable database.

In certain implementations, the data collector 202 can be configured to collect and aggregate task request information from one or more task assignment applications such as task assignment application 106. The data collector 202 can be configured to process the task request information to determine various data related to the task request. For example, the data collector 202 can extract one or more keywords related to the task to be performed, a priority level for the task, a timeline for completion of the task, a billing rate for the task, and other similar task assignment information. For example, the data collector 202 can receive a task request that is formatted as “title: Fix Audio Latency in CWA for Mac; priority: high; time_of_delivery:12-01-21.” The data collector 202 can process the task request information to extract one or more keywords. For example, the data collector 202 can extract “audio, latency, CWA, Mac” from the task assignment data. The data collector 202 can also extract the priority information and the expected time of delivery information from the task assignment information.

The data collector 202 can also be configured to collect employee related data. For example, the data collector 202 can be configured to provide one or more search queries to the employee data source for further processing. For example, the data collector 202 can send a data query based upon the keywords as extracted from the task assignment information, a query based upon the priority of the task, a query based upon the expected date of delivery, and other similar queries based upon the data obtained from the task assignment information. The employee data source 210 can be configured to process the one or more queries as received from the data collector 202 and return a set of search results to the data collector.

For example, the employee data source 210 can be configured to query the employee data 212 to determine a set of search results. In certain implementations, the search results can include information pulled from employee profile data (e.g., what internal team does an employee belong to, what is their educational history, what is there area of expertise), current task information for one or more employees, ongoing and/or upcoming time of information for one or more employees (pulled, for example, from an employee scheduling application via an application programming interface (API) call or other similar process), calendar information for one or more employees pulled from, for example, a calendar application, historical work information for one or more employees, current status for one or more employees (pulled, for example, from a messaging application that monitors current employee activity), and other similar employee information.

In some examples, the data collector 202 can process the results as received from the employee data source 210 and pass the results to the score engine 204. The score engine 204 can be configured to process the search results to generate a task matching score for the one or more employees included in the search results. For example, the score engine 204 can be configured to calculate a score for each of the one or more employees included in the search results based upon the employee information contained within the search results. Depending upon various data in the original task request information, various data related to the one or more employees represented within the search results can be weighted or scored accordingly.

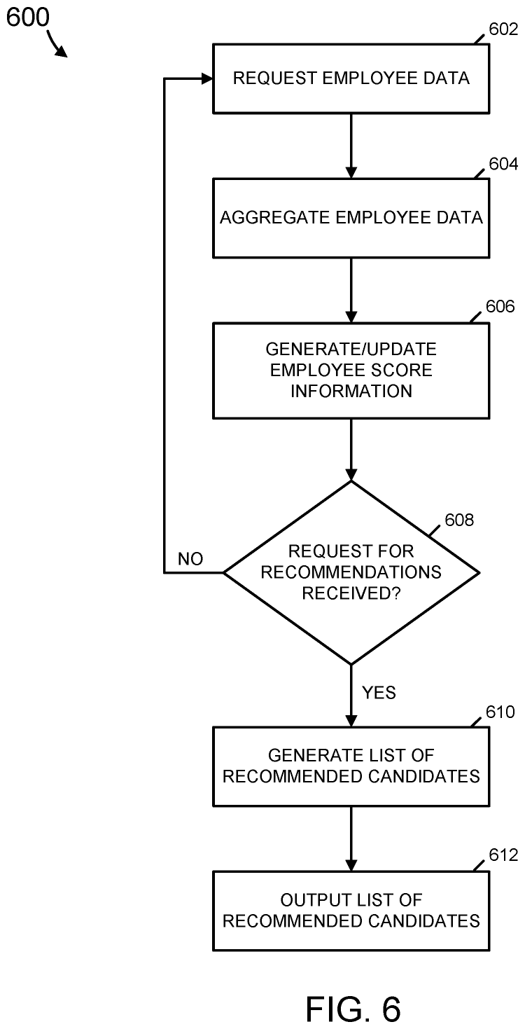

For example, an employee's associated task score can be increased if they have skill information that matches required skills as extracted from the original task assignment information. Similarly, if an employee is a member of an internal team or other similar group that is associated with or otherwise considered to suitable for a skill associated with the task assignment information, the employee's associated task score can be increased accordingly. Regarding availability and task priority, the score engine 204 can consider various factors. For example, if the task assignment information indicates that a task has a high priority, the score engine can consider is an employee currently assigned a task or is the employee idle, does the employee have a higher task currently pending, does the employee have time off scheduled or otherwise have a block of time in their schedule devote to other things (e.g., a string of meetings during the day tomorrow). The score engine 204 can consider each of these factors when assigning an availability score to the one or more employees included in the search results. Specific examples of the score engine generating a matching score for each of the one or more employees is provided below in the discussion of FIGS. 6-9.

Based upon the above factors and considerations, the score engine 204 can assign each of the one or more employees an associated task score and organize the one or more employees into a set of recommended candidates for a particular task. The score engine 204 can pass the set of recommended candidates to the response generator 206 for further processing. In certain implementations, the response generator 206 can be configured to process the set of recommended candidates for display in the user interface of the task assignment application such as task assignment application 106 as shown in FIG. 1 and described above. For example, the response generator 206 can be configured to process the set of recommended candidates and produce an organized list of candidate names, associated task assignment scores, and any additional information related to the candidate for consideration by the person using the task assignment application 106 and assigning the task. The response generator 206 can be further configured to update a user interface (UI) of the task assignment application to include at least a portion of the list of candidate names, associate task assignment scores, and any additional information. For example, the response generator 206 can be configured to call an HTTP API to determine a list of hypertext markup language (HTML) input controls associated with the UI of the task assignment application. The response generator 206 can update one or more of the HTML input controls associated with the UI to display the output information as described above.

As such, the task assignment application system 116 as described herein and shown in FIGS. 1 and 2 can be configured to receive task assignment information from task assignment application 106 and produce an ordered set of candidates for consideration by a user of the task assignment application. Additional information, including specific examples, of the task assignment application system are provided in FIGS. 6-9 and the accompanying descriptions below.

As noted above in FIG. 1, various computing devices can be arranged into one or more interconnected networks to provide user access to remote resources through various client devices. Referring to FIG. 3, a non-limiting network environment 300 provides an alternative arrangement to network 100 as shown in FIG. 1, in which various aspects of the disclosure can be implemented. As shown in FIG. 3, the environment 300 includes one or more client machines 302A-302N, one or more remote machines 306A-306N, one or more networks 304, 304′, and one or more appliances 308 installed within the computing environment 300. The client machines 302A-302N communicate with the remote machines 306A-306N via the networks 304, 304′. The computing environment 300 can also be referred to as a distributed computer system.

In some examples, the client machines 302A-302N communicate with the remote machines 306A-306N via an intermediary appliance 308. The illustrated appliance 308 is positioned between the networks 304, 304′ and can also be referred to as a network interface or gateway. In some examples, the appliance 308 can operate as remote computing device configured to provide clients with access to business applications and other data deployed in a datacenter, the cloud, or delivered as SaaS applications across a range of client devices, and/or provide other functionality such as load balancing, etc. In some examples, multiple appliances 308 can be used, and the appliance(s) 308 can be deployed as part of the network 304 and/or 304′.

The client machines 302A-302N can be generally referred to as client machines 302, local machines 302, clients 302, client nodes 302, client computers 302, client devices 302, computing devices 302, endpoints 302, or endpoint nodes 302. In certain implementations, client machines 302 can include, for example, client device 102 as shown in FIG. 1 and described above.

The remote machines 306A-306N can be generally referred to as servers 306 or a server farm 306. In some examples, a client device 302 can have the capacity to function as both a client node seeking access to resources provided by a server 306 and as a server 306 providing access to hosted resources for other client devices 302A-302N. The networks 304, 304′ can be generally referred to as a network 304. The networks 304 can be configured in any combination of wired and wireless networks.

A server 306 can be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality. In some examples, a server 306 can include the functionality of the workspace host device 110 as shown in FIG. 1 and described above.

A server 306 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol client; a File Transfer Protocol client; an Oscar client; a Telnet client; or any other set of executable instructions.

In some examples, a server 306 can execute a remote presentation services program or other program that uses a thin client or a remote-display protocol to capture display output generated by an application executing on a server 306 and transmit the application display output to a client device 302.

In yet other examples, a server 306 can execute a virtual machine providing, to a user of a client device 302, access to a computing environment. The client device 302 can be a virtual machine. The virtual machine can be managed by, for example, a hypervisor, a virtual machine manager (VMM), or any other hardware virtualization technique within the server 306.

In some examples, the network 304 can be: a LAN; a MAN; a WAN; a primary public network; and a primary private network. Additional examples can include a network 304 of mobile telephone networks that use various protocols to communicate among mobile devices. For short range communications within a WLAN, the protocols can include 802.11, Bluetooth, and NFC. In certain examples, the network 304 can include network 108 as shown in FIG. 1 and described above.

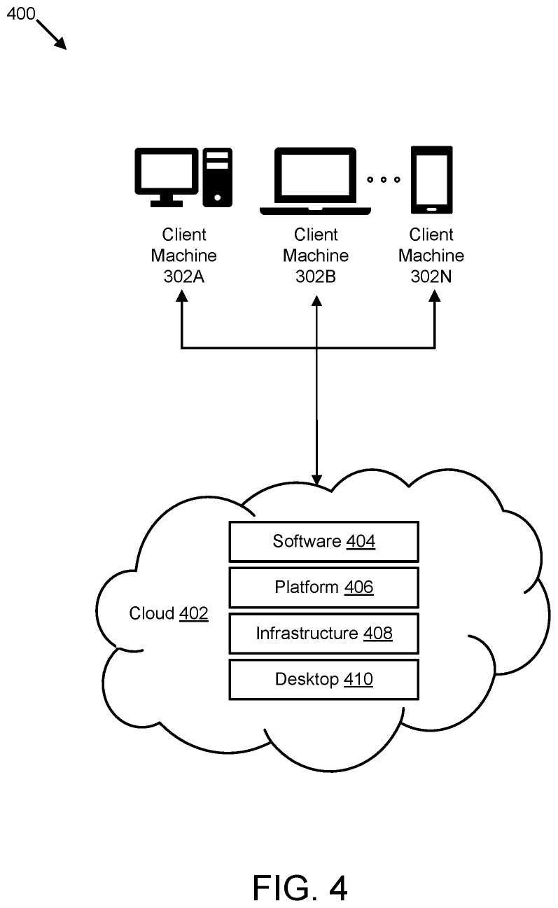

Referring to FIG. 4, a cloud computing environment 400 is depicted, which can also be referred to as a cloud environment, cloud computing platform, or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and other processes.

In the cloud computing environment 400, one or more clients 302a-302n (such as those described above and shown in FIG. 3) are in communication with a cloud network 402. The cloud network 402 can include back-end platforms, e.g., servers, storage, server farms or data centers. The users or clients 302a-302n can correspond to a single organization/tenant or multiple organizations/tenants. More particularly, in one example implementation the cloud computing environment 400 can provide a private cloud serving a single organization (e.g., enterprise cloud). In another example, the cloud computing environment 400 can provide a community or public cloud serving multiple organizations/tenants.

In some examples, a gateway appliance(s) or service can be utilized to provide access to cloud computing resources and virtual sessions. By way of example, Citrix Gateway, provided by Citrix Systems, Inc., can be deployed on-premises or on public clouds to provide users with secure access and single sign-on to virtual, SaaS and web applications. Furthermore, to protect users from web threats, a gateway such as Citrix Secure Web Gateway can be used. Citrix Secure Web Gateway uses a cloud-based service and a local cache to check for uniform resource locator (URL) reputation and category.

In still further examples, the cloud computing environment 400 can provide a hybrid cloud that is a combination of a public cloud and a private cloud. Public clouds can include public servers that are maintained by third parties to the clients 302a-302n or the enterprise/tenant. The servers can be located off-site in remote geographic locations or otherwise.

The cloud computing environment 400 can provide resource pooling to serve multiple users via clients 302a-302n through a multi-tenant environment or multi-tenant model with different physical and virtual resources dynamically assigned and reassigned responsive to different demands within the respective environments. The multi-tenant environment can include a system or architecture that can provide a single instance of software, an application or a software application to serve multiple users. In some implementations, the cloud computing environment 400 can provide on-demand self-service to unilaterally provision computing capabilities (e.g., server time, network storage) across a network for multiple clients 302a-302n. By way of example, provisioning services can be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 302. In some examples, the cloud computing environment 400 can include or provide monitoring services to monitor, control and/or generate reports corresponding to the provided shared services and resources.

In some implementations, the cloud computing environment 400 can provide cloud-based delivery of different types of cloud computing services, such as SaaS 404, Platform as a Service (PaaS) 406, Infrastructure as a Service (IaaS) 408, and Desktop as a Service (DaaS) 410, for example. IaaS can refer to a user renting the use of infrastructure resources that are needed during a specified time period. IaaS providers can offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers can offer functionality provided by IaaS, including, e.g., storage, networking, servers or virtualization, as well as additional resources such as, e.g., operating system, middleware, or runtime resources. Examples of PaaS include WINDOWS AZURE CLOUD provided by Microsoft Corporation of Redmond, Wash. (herein “Azure”), Google App Engine provided by Google Inc., and HEROKU provided by Heroku, Inc. of San Francisco, Calif.

SaaS providers can offer the resources that PaaS provides, including storage, networking, servers, virtualization, operating system, middleware, or runtime resources. In some examples, SaaS providers can offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS can also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms can be hosted on a public cloud computing infrastructure such as Azure, or AMAZON WEB SERVICES provided by Amazon.com, Inc., of Seattle, Wash. (herein “AWS”), for example. In the case of Citrix Cloud, Citrix Workspace application can be used as a single-entry point for bringing apps, files and desktops together (whether on-premises or in the cloud) to deliver a unified experience.

### Task Assignment Candidate Recommendation Processes

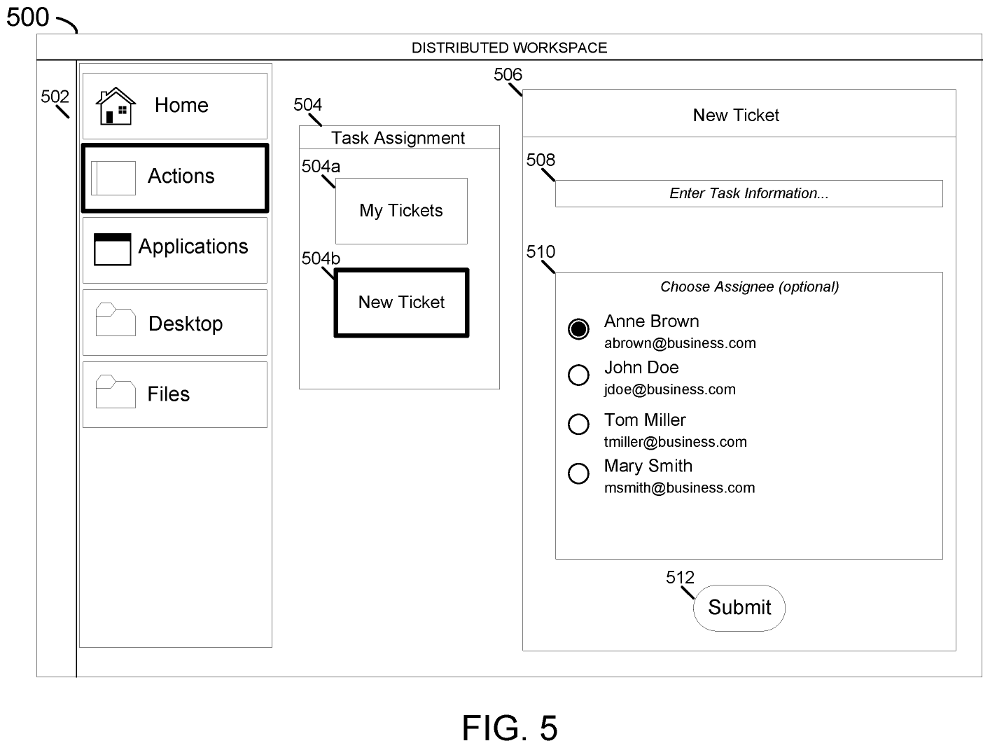

Task assignments can be implemented via one or more task assignment applications such as task assignment application 106 as shown in FIG. 1. An interface of the task assignment application can be implemented as a user accessible control in, for example, an application or a microapp running in as a distributed workspace application. For example, FIG. 5 illustrates a sample view of a user interface screen 500 that is displayed on a client computing device such as computing device 102 as shown in FIG. 1 and described above, and displayed by a workspace application such as, for example, the workspace application 104.

As illustrated in FIG. 5, the screen 500 includes user interface controls 502, 504, 506, 508, 510, and 512. In the example as shown in FIG. 5, each of the user interface controls 502, 504, 506, 508, 510, and 512 is associated with a particular feature within the distributed workspace and/or the task assignment application. For example, the user interface control 502 represents a main directory list of the distributed workspace. A user of the distributed workspace can interact with the user interface control 502 to access one or more features of the distributed workspace. For example, as shown in FIG. 5, the user has selected the item “Actions” from within the user interface control 502. In certain implementations, selecting an option from the user interface control 502 can cause another portion of the associated application or microapp to update or otherwise display additional information. For example, upon selection of “Actions,” the application can update to display the user interface control 504.

As shown in FIG. 5, the user interface control 504 can be an interface for a task assignment application and configured to provide a user of the distributed workspace with additional options and/or information. For example, as shown in FIG. 5, the user interface control 504 can display an additional user interface control 504A for viewing existing task assignment tickets and a user interface control 504B for creating a new task assignment ticket. As shown in FIG. 5, the user has selected the user interface control 504B to create a new task assignment ticket. As such, the screen 500 can update to display the user interface control 506 which includes various options for creating a new task assignment ticket as described herein. For example, the user interface control 506 can include the user interface control 508, the user interface control 510, and the user interface control 512.

As further shown in FIG. 5, the user interface 508 can include a textbox where a user can enter one or more text strings related to the task assignment associated with the new ticket being created. The user can also access user interface control 510 for choosing an assignee to be associated with the new task assignment ticket being created. Upon selection of an assignee, the task assignment application can provide such information to a workspace host device during creation of the new task assignment ticket.

As shown in FIG. 5, the information contained in the user interface control 510 can include limited information such as the name and email address for one or more potential candidates for the new task assignment. The user of the distributed workspace can interact with the user interface control 510 to select one or more of the potential candidates to assign to the new task assignment. In response to such a user selection, the processor running the task assignment application can further process the new task assignment ticket such that it is assigned to the selected assignee. Once the information for the new task assignment ticket is completed, the user of the distributed workspace can select the user interface control 512 to submit the new task assignment ticket for further processing by the task assignment application such that the ticket is created, processed, recorded, and the assignee is informed or otherwise made aware of the new task assignment.

Using the task assignment interface as shown in, for example, FIG. 5 provides the user with limited information related to the potential candidates to assign to a new task assignment. For example, the information provided does not indicate areas of expertise, previous projects worked on, availability, and other information that the user of the distributed workspace may want to consider when selecting one or more candidates to assign to the new task. The following discussion is directed towards an artificially intelligent candidate recommendation system for providing a user creating a new task assignment ticket with additional information, including a matching score, to provide the user with a more complete and robust listing of candidates and candidate information for consideration when assigning a new task assignment to one or more candidates.

FIG. 6 illustrates a sample process 600 for generating recommended candidates for a new task assignment ticket. The process 600 as shown in FIG. 6 can be implemented, for example, by a processor of a computing device such as the workspace host device 110 and/or the task assignment application system 116 as shown in FIG. 1.

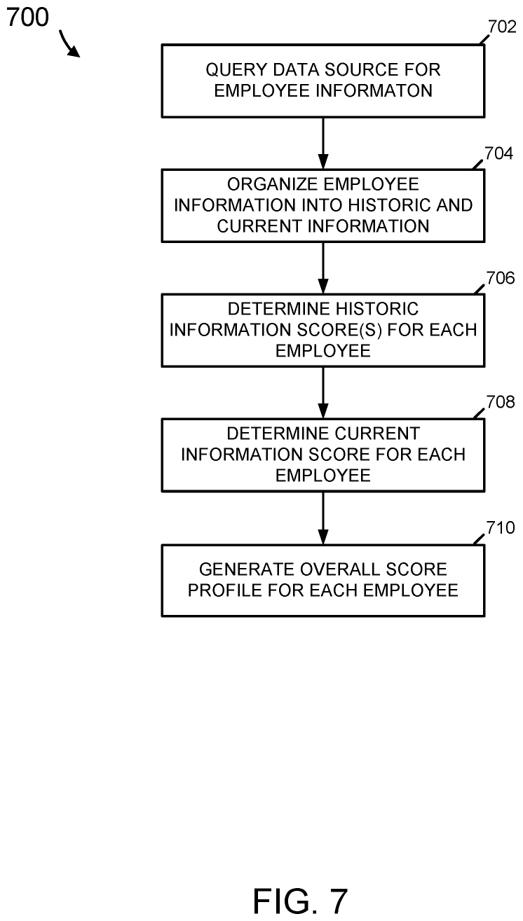

As shown in FIG. 6, the processor can request 602 employee data for a group of employees within an organization. For example, the processor can request 602 the employee data from a data source such as employee data source 210 as shown in FIG. 2 and described above. The processor can further aggregate 604 the employee data as described herein. the processor can generate and/or update 606 employee score information for each employee within the organization. For example, for a new employee, the processor can generate 606 an employee score based upon the aggregated employee data as described herein. For an existing employee, or an employee who has otherwise already been assigned and initial employee score, the processor could update 606 the employee score information based upon, for example, changes to the employee historic information or current information. Additional data relating to requesting and processing the employee data as shown in process 600, as well as generating and/or updating the employee score, is included in the following discussion of FIG. 7.

FIG. 7 Illustrates a sample process 700 for requesting and processing employee information and generating and/or updating score information for an employee as described herein. The process 700 as shown in FIG. 7 can be implemented, for example, by a processor of a computing device such as the workspace host device 110 and/or the task assignment application system 116 as shown in FIG. 1.

As shown in FIG. 7, the processor can be configured to query 702 a data source for employee information. For example, the data source can include employee data source 210 as shown in FIG. 2 and described above. The processor can further organize 704 the employee information into various sets of information. For example, the processor can organize 704 the employee information into historic information and current information. In certain implementations, the historic information can include information related to areas of expertise an employee may have (based upon, for example, employee education information, past employee tasks and projects, team memberships for the employee, and other similar historic information), employment record information, documents authored, assigned roles within an organization, and other similar information. In some examples, the current information can include information related to the employee's current activities such as ongoing tasks and/or projects, current status (e.g., available, in a meeting, busy), upcoming schedule (e.g., tasks assigned for upcoming days, scheduled meetings), and any paid time off coming up.

Based upon the organized information, the processor can determine one or more specific employee scores for each employee. For example, the processor can determine 706 one or more historic information scores for an employee. In certain implementations, the historic score can be organized based upon various keywords, each keyword having an associated score based upon the employee's historic information. For example, an employee may have a historic score associated with a particular skill and a score related to a team to which they were a member. In certain examples, information related to an employee's team can be determined from, for example, an employee's record, an organizational chart, employee activity and project tracking information, and other similar information sources. More specifically, an employee's role and/or team membership may have an associated set of keywords or other labels that are indicative of that employee's areas of expertise and/or working experience. For example, if the employee is a member of a web development team, the employee may have a specific set of related keywords that are evaluated when determining their historic score. In such an example, the employee's area of expertise keywords may include distributed workspace knowledge, JAVA programming, HTML services, API experience, TCP/IP protocol experience, and other similar web service keywords. The processor can analyze records of the employee's past work experience and work product based upon those keywords to determine the employee's historic score. For example, if the employee has generated numerous pieces of code related to JAVA programming, the employee's historic score for web services can be increased.

Similarly, the processor can determine 708 a current information score for each employee based upon the employee's current information. For example, the current information score can be solely based upon the immediate availability of an employee. If an employee is out of the office or otherwise unavailable, their associated availability score can be lowered accordingly. Conversely, if an employee is immediately available to start a new task, their availability score can be increased.

Using the historic information score and the current information score, the processor can generate 710 an overall score profile for each employee. For example, an employee's overall score profile can be represented as:
Name: John Doe
Skills: macOS:90; workspace implementation:85; C++ coding:80, web services: 65
Availability: 95 (one task to be completed tomorrow, no time off planned)

It should be noted that this employee overall score profile is provided by way of example only. Additional score profiles can include additional data related to skills (e.g., historic score information) as well as availability (e.g., current score information).

Referring back to FIG. 6, the processor can determine 608 whether a request for recommendations has been received from, for example, a task assignment application. In certain implementations, as described herein, as a user creates a new task assignment ticket in a task assignment application, information entered into the application can be forwarded to the processor for processing. In certain implementations, a request for candidate recommendations can be included in the information received from the task assignment application as described herein. If the processor determines 608 that there is no request for candidate recommendation, the processor can continue to monitor for a received request for candidate recommendations. In certain implementations, if the processor determines 608 that there is no request for candidate recommendations, the processor can continue to request 602 employee data, aggregate 604 the employee data, and generate and/or update 606 the employee score information. In some examples, the processor can repeat the process steps as shown in FIG. 6 (i.e., requesting 602, aggregating 604, generating and/or updating 606, and determining 608) according to a set schedule or in response to a particular action or event. For example, for each received request, the processor can repeat the process steps to generate/update the employee score information. In some examples, the processor can repeat the process steps whenever an employee's record or other similar information associated with the employee is updated. In some examples, the processor can repeat the process steps according to a predetermined schedule such as daily, weekly, or monthly.

As further shown in FIG. 6, if the processor determines 608 that a request for candidate recommendations has been received, the processor can generate 610 a list of recommended candidates based upon the candidate score information as described herein. The processor can further be configured to output 612 the list of recommended candidates. In certain implementations, the processor can be configured to output at least a portion of the list of recommended candidates. For example, in a user settings configuration associated with the task assignment application, a user can set the number of candidate recommendations they would like to receive when creating a new task assignment ticket.

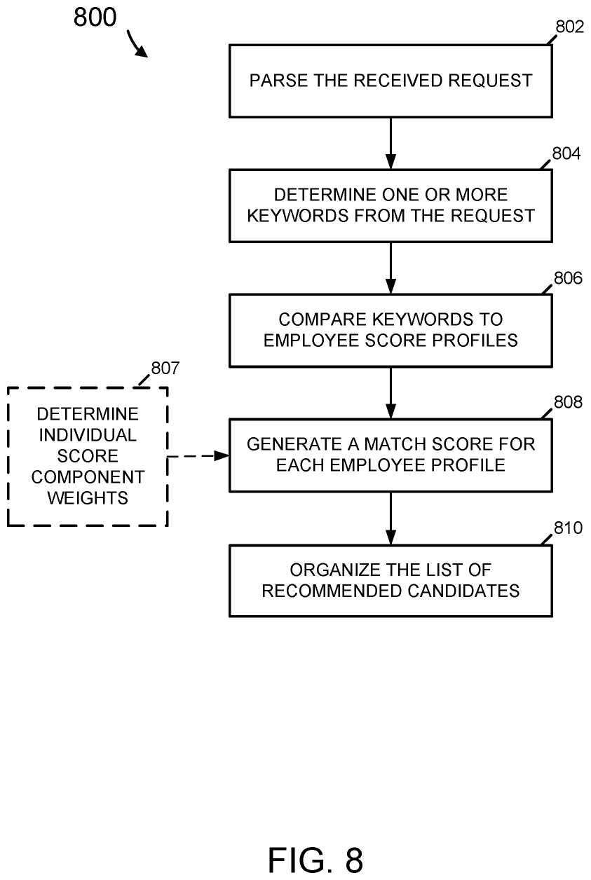

FIG. 8 illustrates a sample process for generating the list of recommended candidates for a task. The process 800 as shown in FIG. 8 can be implemented, for example, by a processor of a computing device such as the workspace host device 110 and/or the task assignment application system 116 as shown in FIG. 1.

In process 800, the processor can parse 802 the received request for candidate recommendations. For example, the processor can perform a keyword search of the request to identify one or more words or phrases that provide additional context related to the request. In certain implementations, the processor can identify keywords related to a subject area associated with the new task assignment, a priority level associated with the new task assignment, and expected date of completion of the new task assignment, and other similar related information. Based upon the parsed information, the processor can determine 804 one or more keywords and important aspects of the request. The processor can further compare 806 the identified keywords and aspects of the request to the employee score profiles as described herein. Based upon the comparison, the processor can generate a match score for each employee profile, the match score indicating a level of appropriateness for an individual employee to be assigned to a particular task such as the new task assignment as described herein. The processor can further organize 810 the list of recommended candidates such that candidates with the highest match score are presented to the user creating the new task application ticket first.

In certain implementations, generating 808 a match score for each employee profile can further include weighing one or more individual score components and keywords as contained within the received request as described herein. For example, if a new task assignment is rated high priority, immediate employee availability may be more important than an employee skill set or team membership. In such an example, the processor can determine 807 one or more individual score component weights such that each individual score is weighted accordingly when the processor determines 808 the match score for each employee profile.

For example, a set of employees may have the following profiles for a specific set of keywords as determined based upon a specific task assignment request:
Name: John Doe
Skill Score: 90
Team Score: 80
Availability Score: 100 (current project completed, no paid time off scheduled)
Name: Anne Brown
Skill Score: 80
Team Score: 80
Availability: 60 (available soon, currently completing a project)
Name: Mary Smith
Skill Score: 40
Team Score: 60
Availability: 10 (paid time off beginning tomorrow)

When determining the match score for each employee represented by one of the above employee profiles the processor can determine one or more important factors for each individual score. As the total match score for an employee can be determined by:

Match_Score=(Skill_score*importance_factor1)+(Team_score*importance_factor2)+(Availability*importance_factor3)

In some examples, the importance factors can be select such that, when summed, they equal 1.0. For example, for a task having a high priority with a low skill set, importance_factor1 (associated with the skills score) can be set to 0.25, importance_factor2 (associated with the team score) can be set to 0.05, and importance_factor3 (associated with availability) can be set to 0.70. In such an example, an employee's availability score is weighted more heavily than their skill score or team score and, as such, a highly ranked recommended candidate returned in the set of recommended candidates for the task will likely have immediate availability.

Additionally, in some examples, when generating 808 the match score for each employee, the processor can be further configured to normalize the match scores into a scale from 0.0 to 1.0. These scores can then be directly converted to a percent match (e.g., 0%-100%) when displaying to the user creating the new task assignment ticket as described herein.

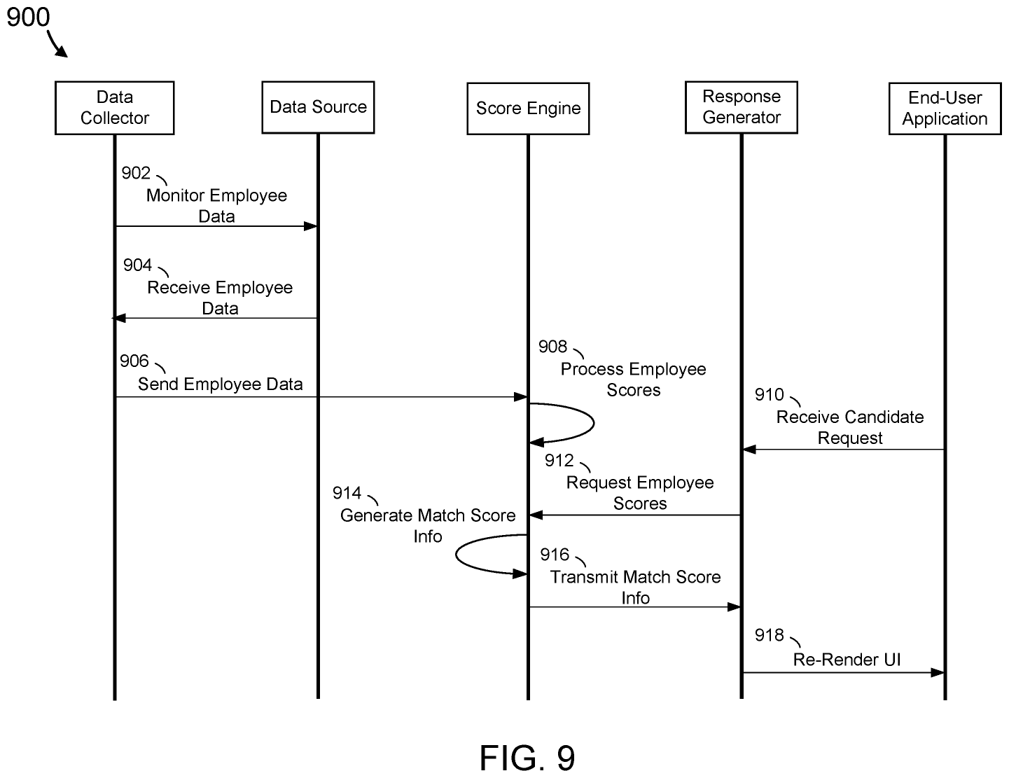

FIG. 9 illustrates a sequence diagram 900 for recommending candidates for a new task assignment being assigned as described herein. More specifically, the sequence diagram 900 shows the interactions between various components as described herein including, but not limited to, a data collector (e.g., the data collector 202 as shown in FIG. 2 and described above), a data source (e.g., the employee data source 210 as shown in FIG. 2 and described above), a score engine (e.g., the score engine 204 as shown in FIG. 2 and described above), a response generator (e.g., the response generator 206 as shown in FIG. 2 and described above), and an end-user application (e.g., the task assignment application 106 as shown in FIG. 1 and described above).

As shown in FIG. 9, the data collector can monitor 902 employee data as stored, for example, at the data source. If employee data stored at the data source is updated, the data collector can receive 904 the updated employee data. The data collector can be further configured to send 906 the employee data to the score engine for further processing. The score engine can receive the employee data and process 908 the employee score information as described herein.

As further shown in FIG. 9, the response generator can receive 910 a request for candidate information from the end-user application. The response generator can process the received request and transmit a request 912 to the score engine for employee score information. The score engine can generate 914 match score information based upon, for example, the processed employee scores and the received candidate request. The score engine can transmit 916 the match score information to the response generator. The response generator can process the match score information, determine, for example, updates to a UI to display the candidate information on the end-user application, and transmit 918 instructions to re-render the UI of the end-user application such that the user of the application can view the candidate information as described herein.

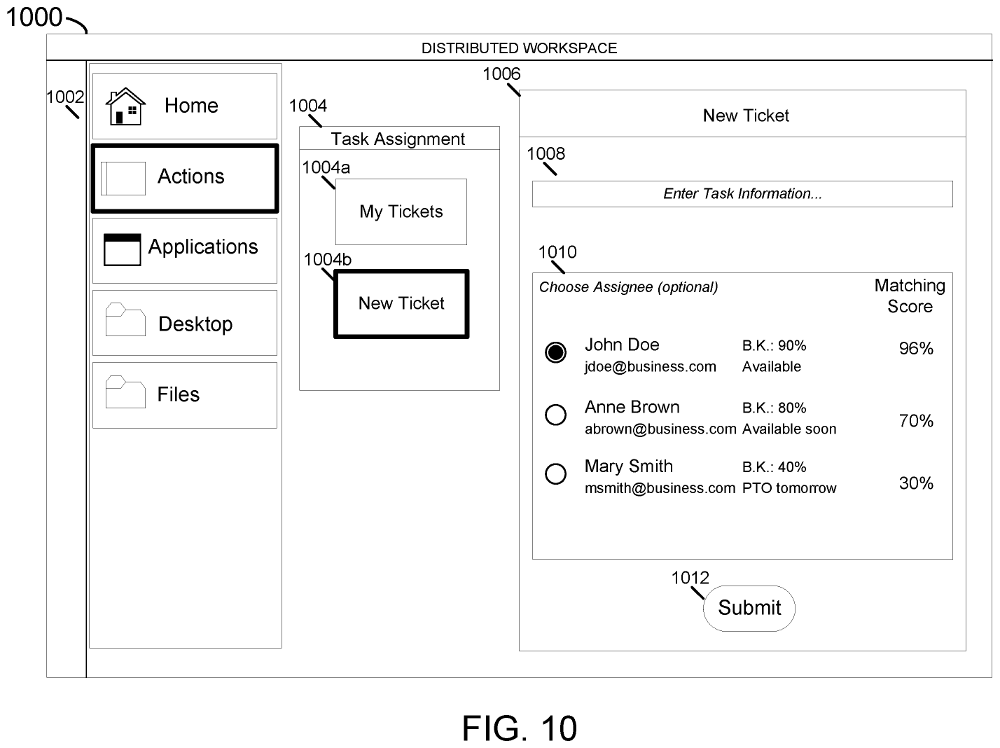

Using the systems and processes as described herein, assigning a new task assignment ticket via a task assignment application can be updated to provide one or more recommended candidates as discussed above. As illustrated in FIG. 10, a screen 1000 includes user interface controls 1002, 1004, 1006, 1008, 1010, and 1012. Similar to screen 500 as shown in FIG. 5 and described above, the screen 1000 illustrates a sample set of user interface controls for interaction with by a user when creating a new task assignment ticket.

In the example as shown in FIG. 10, each of the user interface controls 1002, 1004, 1006, 1008, 1010, and 1012 is associated with a particular feature within the distributed workspace and/or the task assignment application. For example, the user interface control 1002 represents the main directory list of the distributed workspace. As shown in FIG. 10, the user has selected the item “Actions” from within the user interface control 1002. In certain implementations, selecting an option from the user interface control 1002 can cause another portion of the distributed workspace to update or otherwise display additional information. For example, upon selection of “Actions,” the screen 1000 can update to display the user interface control 1004.

As shown in FIG. 10, the user interface control 1004 can be an interface for a task assignment application and configured to provide a user of the distributed workspace with additional options and/or information. For example, as shown in FIG. 10, the user interface control 1004 can display an additional user interface control 1004A for viewing existing task assignment tickets and a user interface control 1004B for creating a new task assignment ticket. As shown in FIG. 10, the user has selected the user interface control 1004B to create a new task assignment ticket. As such, the screen 1000 can update to display the user interface control 1006 which includes various options for creating a new task assignment ticket as described herein. For example, the user interface control 1006 can include the user interface control 1008, the user interface control 1010, and the user interface control 1012.

As further shown in FIG. 10, the user interface 1008 can include a textbox where the user can enter one or more text strings related to the task assignment associated with the new ticket being created. The user can also access user interface control 1010 for choosing an assignee to be assigned to or otherwise associated with the new task assignment ticket being created. Using the systems and process as described herein, the information contained in the user interface control 1010 can include additional information related one or more recommended candidates to complete the new task assignment. For example, as shown in FIG. 10, the user interface control can include a matching score for each of the one or more recommended candidates, and additional information such as a background knowledge score and candidate availability information. It should be noted, however, that the information as shown in the user interface control 1010 is provided by way of example only. Depending upon the implementation of the distributed workspace and the task assignment application, the information shown within the user interface control 1010 can include additional information for the one or more candidates such as current project information, current status information, team information, manager information, frequency collaborator information, and other similar information that may be useful to someone assigning a new task when evaluating candidates. The user of the distributed workspace can interact with the user interface control 1010 to select one or more of the recommended candidates to assign to the new task assignment. In certain implementations, the user interface control 1010 can be configured to default to the recommended candidate with the highest matching score. Once the information for the new task assignment ticket is completed, the user of the distributed workspace can select the user interface control 1012 to submit the new task assignment ticket.

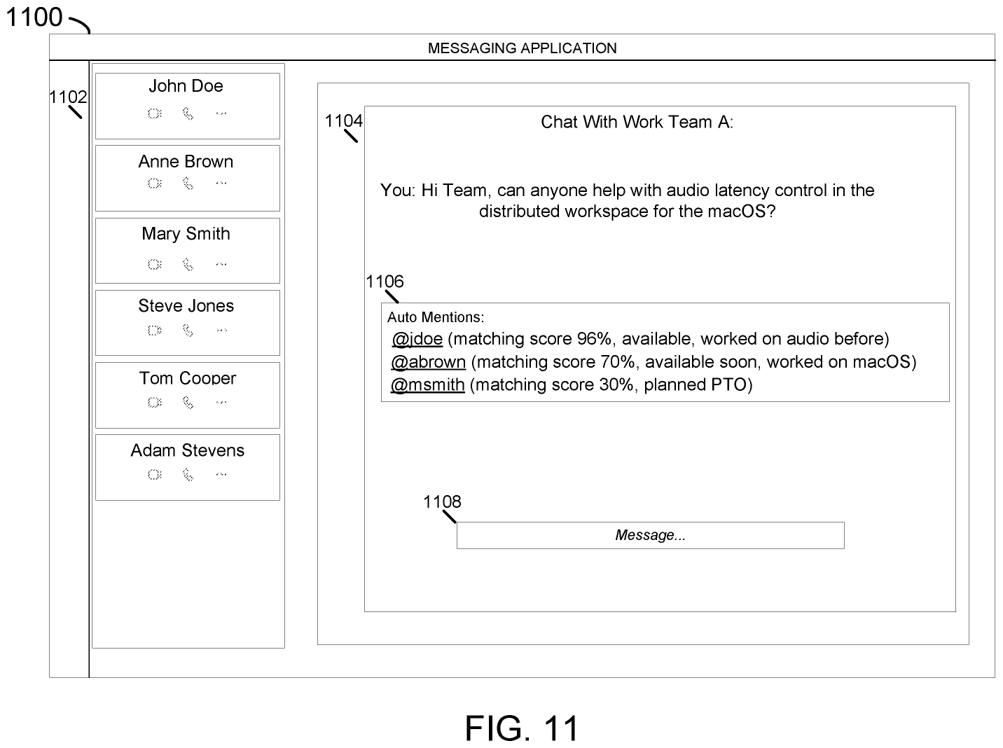

In addition to providing the recommended candidates for a new task assignment as described herein within a task assignment application, the systems and processes described above can also be used with additional applications such as, for example, a messaging application within a distributed workspace. FIG. 11 illustrates a sample shot of screen 1100 of a messaging application that includes task assignment candidate recommendations as described herein.

As illustrated in FIG. 11, the screen 1100 includes user interface controls 1102, 1104, 1106, and 1108. In the example as shown in FIG. 11, each of the user interface controls 1102, 1104, and 1108 is associated with a particular feature within the messaging application. For example, the user interface control 1102 represents a contact list of the user of the messaging application. In certain implementations, the contact list can include user-selected contacts such as friends or close coworkers as well as members of a group or team to which the user of the messaging application also belongs. For example, a group of contacts can include people that all share the same supervisor, are all assigned to the same task, all work in the same physical office, or share another common trait. For example, group or team information can be retrieved from an organizational directory service such as an active Microsoft directory service.

As further shown in FIG. 11, user interface control 1104 can include a chat window. In the example shown in FIG. 11, the user of the messaging application is engaged in a messaging session with a team of coworkers nicknamed “Work Team A.”. The user interface control 1104 further includes an additional user interface control 1108 that the user of the messaging application can use to type and submit an additional message within the overall messaging session as included in user interface control 1104.

The messaging application can further include user interface control 1106 that includes a set of recommended candidates for completing a task being discussed within the group chat. For example, the chat application can be configured to parse the information being exchanged and contained within the chat window for indications or keywords that may be associated with a new task. For example, as shown in FIG. 11, the inclusion of the word “help” and the question mark in the initial chat string can provide an indication that a new task is being discussed. The chat application can then interoperate with, for example, the task assignment application and task assignment application system (e.g., task assignment application system 116 as shown in FIG. 1 and described above) to generate one or more recommended candidates for the new task being discussed. As further shown in FIG. 11, the user interface control 1104 displaying the chat session can be updated to include the user interface control 1106 including the list of recommended candidates for the task being discussed. The user interface control 1106 can be configured to be displayed only to the person that has requested the new task or, in some examples, to the entire group chat.

### Hardware Implementation Examples

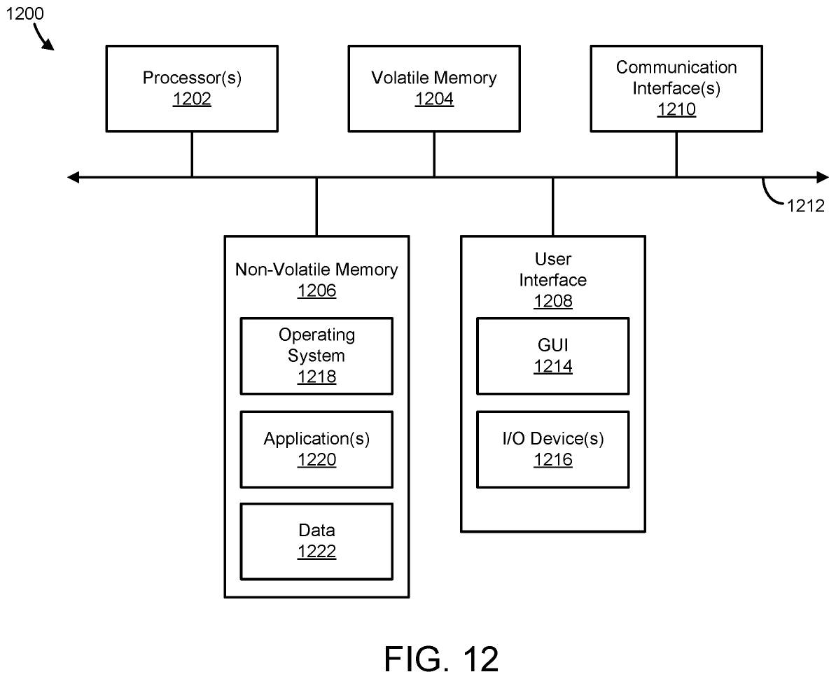

FIG. 12 depicts a block diagram of a computing device 1200 useful for practicing an example of client device 102 and/or workspace host device 110 as shown in FIG. 1 and described above. The computing device 1200 includes one or more processors 1202, volatile memory 1204 (e.g., random access memory (RAM)), non-volatile (non-transitory) memory 1206, UI 1208, one or more communications interfaces 1210, and a communications bus 1212. One or more of the computing devices 1200 can also be referred to as a computer system.

The non-volatile memory 1206 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 1208 can include a graphical user interface (GUI) 1214 (e.g., a touchscreen, a display, etc.) and one or more input/output (I/O) devices 1216 (e.g., a mouse, a keyboard, a microphone, one or more speakers, one or more cameras, one or more biometric scanners, one or more environmental sensors, and one or more accelerometers, etc.).

The non-volatile memory 1206 can store an operating system 1218, one or more applications 1220, and data 1222 such that, for example, computer instructions of the operating system 1218 and/or the applications 1220 are executed by processor(s) 1202 out of the volatile memory 1204. In some examples, the volatile memory 1204 can include one or more types of RAM and/or a cache memory that can offer a faster response time than a main memory. Data can be entered using an input device of the GUI 1214 or received from the I/O device(s) 1216. Various elements of the computing device 1200 can communicate via the communications bus 1212.

The illustrated computing device 1200 is shown merely as an example client device or server and can be implemented by any computing or processing environment with any type of machine or set of machines that can have suitable hardware and/or software capable of operating as described herein.

The processor(s) 1202 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 1202 can be analog, digital or mixed. In some examples, the processor 1202 can include multiple processor cores and/or multiple processors configured to provide functionality for parallel, simultaneous execution of instructions or for parallel, simultaneous execution of one instruction on more than one piece of data.

The communications interfaces 1210 can include one or more interfaces to enable the computing device 1200 to access a computer network such as a Local Area Network (LAN), a Wide Area Network (WAN), a Personal Area Network (PAN), or the Internet through a variety of wired and/or wireless connections, including cellular connections.

In described examples, the computing device 1200 can execute an application on behalf of a user of a client device (e.g., client device 102 as shown in FIG. 1 and described above). For example, the computing device 1200 can execute one or more virtual machines managed by a hypervisor and accessed via, for example, a client agent. Each virtual machine can provide an execution session within which applications execute on behalf of a user or a client device, such as a hosted desktop session. The computing device 1200 can also execute a terminal services session to provide a distributed workspace environment. The computing device 1200 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A computing device configured to provide recommended candidates for completion of an assigned task to a user assigning the task, the computing device comprising:
a memory;
a user interface; and
at least one processor coupled to the memory and the user interface and configured to:
receive input specifying information regarding the task,
determine one or more task specifics associated with the task from the task information,
identify candidate value information regarding one or more candidates to complete the task,
compare the one or more task specifics to the candidate value information regarding the one or more candidates to determine one or more match scores of the one or more candidates,
organize a list of recommended candidates based upon the one or more match scores, and
display, on the user interface, at least a portion of the list of recommended candidates.

2. The computing device of claim 1, wherein the one or more task specifics comprise data specifying one or more of area of expertise, a priority level, or an expected completion date, the at least one processor being further configured to:
determine the one or more match scores of the one or more candidates based upon at least one of the area of expertise associated with the task, the priority level associated with the task, and the expected completion date associated with the task.

3. The computing device of claim 1, the at least one processor being configured to determine one or more task specifics associated with the task from the task information comprises the at least one processor being further configured to:
parse a text string contained within the task information to determine one or more keywords; and
identify one or more of an area of expertise, a priority level, or an expected completion date based upon the one or more keywords.

4. The computing device of claim 3, wherein the processor being configured to identify candidate value information regarding one or more candidates to complete the task comprises the at least one processor is further configured to:
determine historic information for each of the one or more candidates; and
determine current availability information for each of the one or more candidates.

5. The computing device of claim 4, the at least one processor being configured to compare the one or more task specifics to the candidate value information regarding the one or more candidates to determine the one or more match scores of the one or more candidates comprises the at least one processor being configured to:
compare the one or more keywords against the historic information to generate a historical working score for each of the one or more candidates;
compare the one or more keywords against the current availability information to generate a current working score for each of the one or more candidates; and
combine at least a portion of the historical working score and the current working score for each of the one or more candidates to determine the one or more match scores.

6. The computing device of claim 5, wherein the at least one processor is further configured to weight an impact of each of the historical working score and the current working score on the one or more match scores based upon at least one of the area of expertise associated, the priority level, and the expected completion date.

7. The computing device of claim 1, wherein the at least one processor is further configured to:
receive user-inputted task information during generation of a new task assignment ticket within a task assignment application; and
display, on the user interface, the at least a portion of the list of recommended candidates within the task assignment application during creation of the new task assignment ticket.

8. A method for providing recommended candidates for completion of an assigned task to a user assigning the task, the method comprising:
receiving, by at least one processor, input specifying information regarding the task;
determining, by the at least one processor, one or more task specifics associated with the task from the task information;
identifying, by the at least one processor, candidate value information regarding one or more candidates to complete the task;
comparing, by the at least one processor, the one or more task specifics to the candidate value information regarding the one or more candidates to determine one or more match scores of the one or more candidates;
organizing, by the at least one processor, a list of recommended candidates based upon the one or more match scores; and
displaying, by the at least one processor on a user interface operably coupled to the at least one processor, at least a portion of the list of recommended candidates.

9. The method of claim 8, wherein the one or more task specifics comprise data specifying one or more of area of expertise, a priority level, and an expected completion date, the method further comprising:
determining, by the at least one processor, the one or more match scores of the one or more candidates based upon at least one of the area of expertise associated with the task, the priority level associated with the task, and the expected completion date associated with the task.

10. The method of claim 8, wherein determining one or more task specifics associated with the task from the task information comprises:
parsing, by the at least one processor, a text string contained within the task information to determine one or more keywords; and
identifying, by the at least one processor, one or more of an area of expertise, a priority level, or an expected completion date based upon the one or more keywords.

11. The method of claim 10, wherein identifying candidate value information regarding one or more candidates to complete the task comprises:
determining, by the at least one processor, historic information for each of the one or more candidates; and
determining, by the at least one processor, current availability information for each of the one or more candidates.

12. The method of claim 11, wherein comparing the one or more task specifics to the candidate value information regarding the one or more candidates to determine the one or more match scores of the one or more candidates comprises:
comparing, by the at least one processor, the one or more keywords against the historic information to generate a historical working score for each of the one or more candidates;
comparing, by the at least one processor, the one or more keywords against the current availability information to generate a current working score for each of the one or more candidates; and
combining, by the at least one processor, at least a portion of the historical working score and the current working score for each of the one or more candidates to determine the one or more match scores.

13. The method of claim 12, further comprising weighting, by the at least one processor, an impact of each of the historical working score and the current working score on the one or more match scores based upon at least one of the area of expertise associated, the priority level, and the expected completion date.

14. The method of claim 8, further comprising:
receiving, by the at least one processor, user-inputted task information during generation of a new task assignment ticket within a task assignment application; and
displaying, by the at least one processor on the user interface, the at least a portion of the list of recommended candidates within the task assignment application during creation of the new task assignment ticket.

15. A non-transitory computer-readable medium storing computer-executable instructions to provide recommended candidates for completion of an assigned task to a user assigning the task, the instructions comprising instructions to:
receive input specifying information regarding the task;
determine one or more task specifics associated with the task from the task information;
identify candidate value information regarding one or more candidates to complete the task;
compare the one or more task specifics to the candidate value information regarding the one or more candidates to determine one or more match scores of the one or more candidates;
organize a list of recommended candidates based upon the one or more match scores; and
display, on a user interface operably coupled to the non-transitory computer readable medium, at least a portion of the list of recommended candidates.

16. The non-transitory computer-readable medium of claim 15, wherein the one or more task specifics comprise data specifying one or more of area of expertise, a priority level, or an expected completion date, and the instruction further comprise instructions to:
determine the one or more match scores of the one or more candidates based upon at least one of the area of expertise associated with the task, the priority level associated with the task, and the expected completion date associated with the task.

17. The non-transitory computer-readable medium of claim 15, wherein the instructions to determine one or more task specifics associated with the task from the task information comprise instructions to:
parse a text string contained within the task information to determine one or more keywords; and
identify one or more of an area of expertise, a priority level, or an expected completion date based upon the one or more keywords.

18. The non-transitory computer-readable medium of claim 17, wherein the instructions to identify candidate value information regarding one or more candidates to complete the task comprise instructions to:
determine historic information for each of the one or more candidates; and
determine current availability information for each of the one or more candidates.

19. The non-transitory computer-readable medium of claim 18, wherein the instructions to compare the one or more task specifics to the candidate value information regarding the one or more candidates to determine the one or more match scores of the one or more candidates comprise instructions to:
compare the one or more keywords against the historic information to generate a historical working score for each of the one or more candidates;
compare the one or more keywords against the current availability information to generate a current working score for each of the one or more candidates;
combine at least a portion of the historical working score and the current working score for each of the one or more candidates to determine the one or more match scores; and
weight an impact of each of the historical working score and the current working score on the one or more match scores based upon at least one of the area of expertise associated, the priority level, and the expected completion date.

20. The non-transitory computer-readable medium of claim 15, wherein the instructions further comprise instructions to:
receive user-inputted task information during generation of a new task assignment ticket within a task assignment application; and
display, on the user interface, the at least a portion of the list of recommended candidates within the task assignment application during creation of the new task assignment ticket.
